(19) United States
(12) Patent Application Publication
(10) Pub. No.: US 2022/0229229 A1
(43) Pub. Date: Jul. 21, 2022

(54) Surface Emission Optical Circuit and Surface Emission Light Source Using the Same

(71) Applicant: Nippon Telegraph and Telephone Corporation, Tokyo (JP)

(72) Inventors: Yusuke Saito, Musashino-shi, Tokyo (JP); Yuta Ueda, Musashino-shi, Tokyo (JP); Mitsuteru Ishikawa, Musashino-shi, Tokyo (JP)

(21) Appl. No.: 17/616,329

(22) PCT Filed: Jun. 7, 2019
(86) PCT No.: PCT/JP2019/022806

§ 371 Date: Dec. 3, 2021

(51) Int. Cl. G02B 6/12; G02B 6/125

(52) U.S. Cl. CPC G02B 6/12004; G02B 2006/12104; G02B 6/125

(57) ABSTRACT

To provide a surface emitting type optical device capable of appropriate on-wafer measurement without affecting element characteristics, low-cost manufacturing, and high-density packaging. This surface emitting type light source includes, in an optical waveguide having a semiconductor laser region formed on a top surface being one main surface of a semiconductor substrate and a spot size converter region leading thereto, a reflective mirror that reflects light emitted from the laser into free space via the converter to the top surface side of the substrate. A p-type drive electrode in the laser region and an insulating layer in the converter region are provided on the top surface of the substrate, and an n-type drive electrode in the laser region is provided on a bottom surface of the other main surface of the substrate. In the laser, current injection into an active layer using various electrodes generates an optical gain in the active layer.

### TECHNICAL FIELD

The present invention relates to a surface emitting type optical circuit in which an optical device is monolithically integrated on a top surface of a substrate and that has a function capable of suppressing the spread of emitted light and a surface emitting type light source applied with the same.

### BACKGROUND ART

In recent years, along with progress in information and communication technology, the traffic of optical communication systems has been rapidly increasing. In order to achieve both high speed and low power consumption of networks that may respond such demands, further miniaturization of devices for optical communication (hereinafter referred to as optical devices) is required.

A technology of a lens integrated surface emitting laser (LISEL) disclosed in Non Patent Literature (NPTL) 1 that will be described below has been known as one of such compact optical devices.

### CITATION LIST

### Non Patent Literature

NPTL 1: T. Suzuki et al. “Cost-Effective Optical Sub-Assembly Using Lens-Integrated Surface-Emitting Laser”, J. Lightwave. Technol., Vol. 34, No. 2, pp. 358-364, Jan. 15, 2016.

The LISEL is a high density integrated optical circuit of a semiconductor laser, a reflective mirror, and a lens, and is capable of low loss coupling to an optical fiber, an optical circuit provided on a top surface of a silicon substrate, and the like. The LISEL also has an advantage capable of being easily arrayed to be coupled to an optical fiber array, such as a parallel single mode (PSM) fiber.

### SUMMARY OF THE INVENTION

### Technical Problem

Incidentally, recent optical devices are also required to allow not only high density packaging, but also low cost manufacturing. In order to achieve such demands, for example, simplifying an inspection process is one factor that embodies the lower cost of the optical devices.

Specifically, an electronic circuit integrated on a silicon wafer can measure element characteristics without dicing (commonly referred to as on-wafer measurement). When elements fabricated on a large diameter wafer can be simplified and inspection can be performed in a quick manner, it is possible to reduce the number of steps and cost that are required for the inspection. This leads to lower cost in dicing the wafer into chips to produce optical devices.

The LISEL described above has a structure in which a semiconductor substrate is provided with a light emitting surface and an electrode that are prepared on mutually opposite surfaces (indicating a top surface serving as one main surface and a bottom surface serving as the other main surface) of the semiconductor substrate. For this reason, it is necessary to perform inspection of light output by cleaving a wafer and mounting the cleaved wafer on a chip carrier. Such an inspection process is considerably cumbersome.

As a technique for performing on-wafer measurement of an optical circuit, a method has been proposed in which light is emitted perpendicularly to a wafer by using a grading coupler provided in the optical circuit, and the on-wafer measurement is performed.

However, a result of the on-wafer measurement according to such a method includes wavelength dependency of the grating coupler and the reflected light at a coupling portion affects element characteristics. Due to such a circumstance, it is difficult to perform on-wafer measurement of the characteristics of the element itself.

An embodiment of the present invention has been made to solve such a problem. The technical challenge is to provide a surface emitting type optical device that is capable of appropriate on-wafer measurement without affecting element characteristics, that can be manufactured at low cost, and that is capable of high density packaging.

### Means for Solving the Problem

In order to achieve the object described above, an embodiment of the present invention is a surface emitting type optical circuit including a spot size converter; a substrate; and an optical waveguide formed on a side of a top surface serving as one main surface of the substrate, wherein the spot size converter is provided in an end region of the optical waveguide, the optical waveguide emits light into free space via the spot size converter, the surface emitting type optical circuit further includes a reflective mirror configured to reflect light emitted from the optical waveguide toward the top surface.

In order to achieve the object described above, another embodiment of the present invention is a surface emitting type light source applied with the surface emitting type optical circuit, the surface emitting type light source includes a light source, and the light source is integrated on the side of the top surface of the substrate.

### Effects of the Invention

According to an embodiment of the present invention, the former and latter configurations allow suitable on-wafer measurement without affecting element characteristics, and a surface emitting optical device that can be manufactured at low cost and that is capable of high density packaging can be obtained. Note that the higher speed and larger capacity is exhibited as the effect of applying such an optical device to the construction of an optical communication system.

### BRIEF DESCRIPTION OF DRAWINGS

FIG. 1 is a plan view from a top surface direction illustrating a basic configuration of a surface emitting type light source according to a first embodiment as an example in which a surface emitting type optical circuit of the present invention is applied.

FIG. 2 is a cross-sectional view illustrating a side structure of the surface emitting type light source in a line II-II direction in FIG. 1.

FIG. 3 is a diagram showing a calculation result for a spread effect of light caused by a spot size converter of the surface emitting type light source illustrated in FIG. 1.

FIG. 4 is a diagram showing, by way of comparison, a calculation result for a spread effect of light when the surface emitting type light source illustrated in FIG. 1 does not have a spot size converter.

FIG. 5 is a diagram showing a calculation result for a spread effect of light when a mode field diameter of light caused by the spot size converter of the surface emitting type light source illustrated in FIG. 1 is 2.0 μm.

FIG. 6 is a cross-sectional view illustrating an end face structure of the surface emitting type light source in a line VI-VI direction in FIG. 1.

FIG. 7 is a cross-sectional view in an end face direction illustrating a basic structure of a multi-core fiber to be used for coupling light that is branched by a surface emitting type light source according to a second embodiment as another example in which the surface emitting type optical circuit of the present invention is applied.

FIG. 8 is a plan view from a top surface direction illustrating a basic configuration of the surface emitting type light source illustrated in FIG. 7.

### DESCRIPTION OF EMBODIMENTS

A surface emitting type optical circuit of the present invention and a surface emitting type light source applied with the same will be described below in detail with reference to the drawings.

### First Embodiment

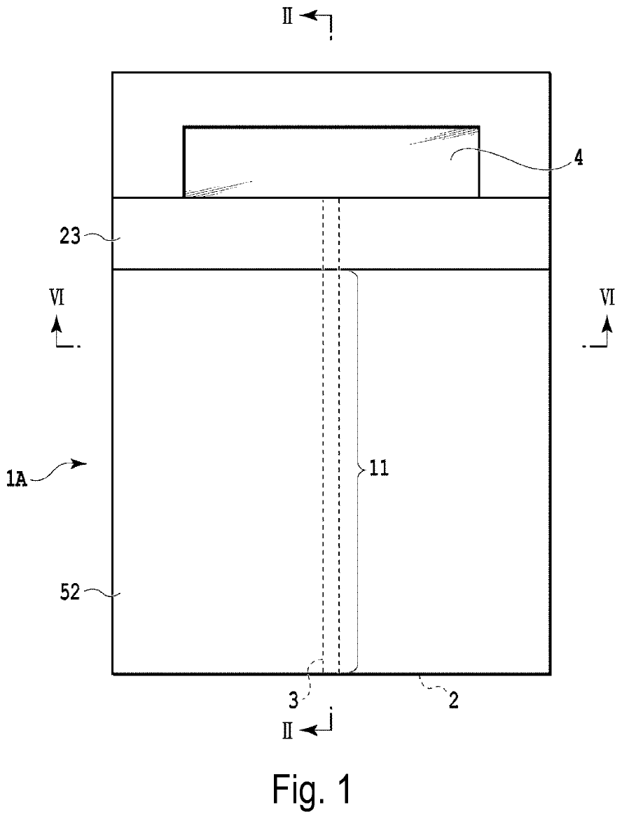

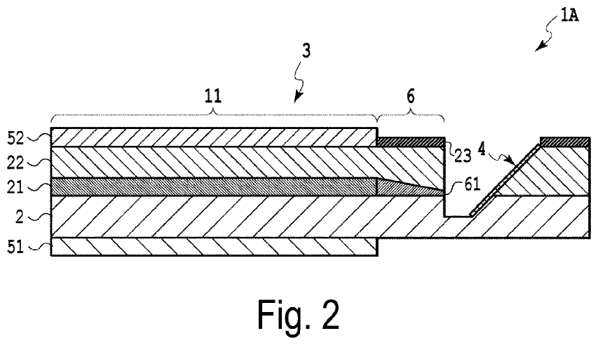

FIG. 1 is a plan view from a top surface direction illustrating a basic configuration of a surface emitting type light source 1A according to a first embodiment as an example in which a surface emitting type optical circuit of the present invention is applied. Additionally, FIG. 2 is a cross-sectional view illustrating a side structure of the surface emitting type light source 1A in a line II-II direction in FIG. 1.

With reference to FIGS. 1 and 2, the surface emitting type light source 1A includes a semiconductor laser 11 formed on a side of a top surface of one main surface of a semiconductor substrate 2. Additionally, the surface emitting type light source 1A includes a ridge type optical waveguide 3 formed on the side of the top surface of the one main surface of the semiconductor substrate 2, and a p-type drive electrode 52 is formed on a top surface of the optical waveguide 3. Note that the semiconductor laser 11 is included in the optical waveguide 3.

Furthermore, the surface emitting type light source 1A includes a reflective mirror 4 that reflects light emitted from the optical waveguide 3 toward the side of the top surface of the semiconductor substrate 2. Examples of a material of the semiconductor substrate 2 include n-type indium phosphide InP. However, a material of the surface emitting type light source 1A is not limited to a semiconductor.

A detailed structure of the surface emitting type light source 1A will be described with reference to FIG. 2. The surface emitting type light source 1A includes a structure in which an active layer 21 having an optical gain, a semiconductor layer 22, and an insulating layer 23 are laminated in this order on the top surface of the semiconductor substrate 2. The optical waveguide 3 has a ridge type structure in which the active layer 21 serves as a core and the semiconductor substrate 2 and the semiconductor layer 22 serve as cladding layers. However, a form of the optical waveguide 3 is not limited to a ridge type structure, and may be, for example, an embedded structure or the like.

Examples of a material of the active layer 21 include an InGaAsP-based material, a multiple quantum well structure thereof, and the like that have various composition ratios and film thicknesses. Examples of a material of the semiconductor layer 22 include p-type indium phosphide InP. Examples of a material of the insulating layer 23 include silicon dioxide SiO₂ and the like.

The optical waveguide 3 includes the semiconductor laser 11 and a spot size converter 6, and is configured such that the spot size converter 6 is connected to an end region of the semiconductor laser 11. In the semiconductor laser 11, when a current is injected into the active layer 21 by using the p-type drive electrode 52 provided on a top surface of the semiconductor layer 22 and an n-type drive electrode 51 provided on a bottom surface serving as the other main surface of the semiconductor substrate 2, an optical gain is generated in the active layer 21. Incidentally, the semiconductor laser 11 may be a distributed feedback (DFB) laser or the like including a diffraction grating on an upper portion of the active layer 21.

The reflective mirror 4 integrated on the top surface of the semiconductor substrate 2 is fabricated so as to have a structure in which the semiconductor layer 22 is inclined by 45 degrees. In general, air has a lower refractive index than that of the material of the semiconductor layer 22, and a difference in refractive index between the air and the material of the semiconductor layer 22 occurs, which makes it available as the reflective mirror 4. However, the angle of inclination of the reflective mirror 4 is not limited to 45 degrees, and the surface of the reflective mirror 4 may be a curved surface, such as a paraboloid. Moreover, the outermost surface of the reflective mirror 4 on the side of the top surface of the semiconductor substrate 2 may be covered with a metal, a dielectric multilayer film, or the like.

The reflective mirror 4 reflects light emitted from one end of the semiconductor laser 11 via the spot size converter 6 toward the side of the top surface of the semiconductor substrate 2. Incidentally, in the semiconductor substrate 2, one main surface on the side laminating the active layer 21 and the semiconductor layer 22 is referred to as a top surface, and the other main surface opposing to the one main surface is referred to as a bottom surface.

Now, when a configuration of a surface emitting type optical circuit that serves as a base material of the surface emitting type light source 1A is assumed, there are two essential points on the configuration. One of the essential points is that the spot size converter 6 is provided in an end region of the optical waveguide 3. The other is that the reflective mirror 4 that reflects light emitted from the optical waveguide 3 toward the side of the top surface of the semiconductor substrate 2 is provided. When the configuration further has a light source (semiconductor laser 11) integrated on the side of the top surface of the semiconductor substrate 2, the configuration can be regarded as the surface emitting type light source 1A.

In this regard, the p-type drive electrode 52 is formed in a region of the semiconductor laser 11 on the top surface of the semiconductor layer 22. However, rather than the p-type drive electrode 52, the insulating layer 23 is formed in a region of the spot size converter 6. In addition, on the bottom surface of the semiconductor substrate 2, the n-type drive electrode 51 is formed in the region of the semiconductor laser 11, but the n-type drive electrode 51 is not formed in the region of the spot size converter 6.

Concerning optical gain characteristics of the active layer 21, an optical gain is generated in the region of the semiconductor laser 11 when a current is injected into the active layer 21, but a core layer 61 in the region of the spot size converter 6 that is continuous to the region of the semiconductor laser 11 does not generate an optical gain. While this spot size converter 6 mitigates the confinement of light in a vertical direction, the larger the spot size is, the smaller the angle of diffraction at the opening thereof is.

In the surface emitting type light source 1A according to the first embodiment, the reflective mirror 4 is fabricated by etching the semiconductor layer 22 regrown on the top surface of the semiconductor substrate 2. Thus, the height of the reflective mirror 4 (a dimension in a direction perpendicular to the flat surface of the semiconductor substrate 2) is determined by the regrowth thickness of the semiconductor layer 22 and the depth of etching.

Light emitted from the end face of the optical waveguide 3 spreads along with spatial propagation. Thus, depending on a relationship between a distance between the end face of the optical waveguide 3 and the reflective mirror 4 and a mode field diameter of light, the height of the reflective mirror 4 may be insufficient, and vignetting of the light may occur.

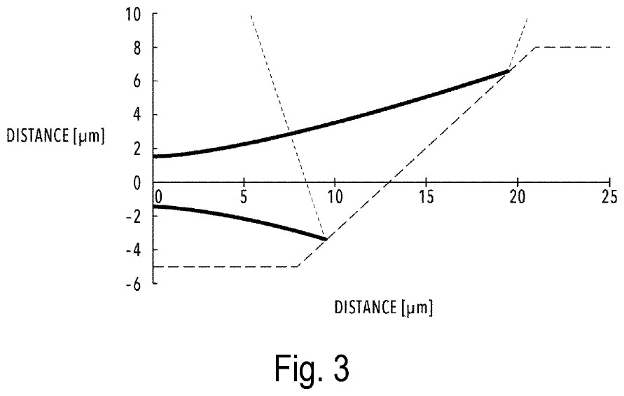

FIG. 3 is a diagram showing a calculation result for a spread effect of light caused by the spot size converter 6 of the surface emitting type light source 1A according to the first embodiment. In other words, here, a calculation result is shown when a mode field diameter of light is 3 μm, and right-side emission is performed with a point of intersection of the vertical (Y) axis and the horizontal (X) axis serving as a spot center. Here, the right-side emission means a case in which light with such a point of intersection serving as a spot center is emitted to the right side with X=0 serving as the end face. Note that in FIG. 3, Gaussian mode light having a wavelength of 1.55 μm is assumed, and its mode field is indicated by using solid lines. In addition, the outermost surfaces of the reflective mirror 4 and the semiconductor substrate 2 are indicated by a dashed line, and the mode field of the light reflected by the reflective mirror 4 is indicated by dotted lines.

With reference to FIG. 3, in a case where the spot size converter 6 is integrated, when a mode field diameter (MFD) of light is spread to 3μm, the spread of light emitted from the end face of the optical waveguide 3 is suppressed. In this regard, the MFD indicates a size in a direction perpendicular to the semiconductor substrate 2. Additionally, as illustrated in FIG. 3, light can be emitted to the side of the top surface of the semiconductor substrate 2.

FIG. 3 indicates a calculation example when a regrown thickness of the surface emitting type light source 1A is 8 μm, and a depth of the lower cladding layer that has been over-etched is 5 μm, but it is also possible to further reduce the height of the reflective mirror 4 with the same MFD. The reflective mirror 4 can be designed from a height of 4.5 μm.

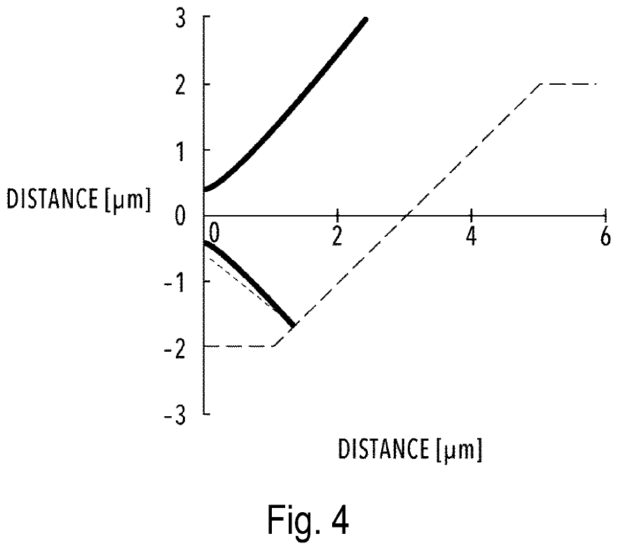

FIG. 4 is a diagram showing, by way of comparison, a calculation result for a spread effect of light when the surface emitting type light source 1A does not have the spot size converter 6. Here, it is assumed that an MFD is 0.8 μm, and right-side emission is performed with a point of intersection of the vertical (Y) axis and the horizontal (X) axis serving as a spot center. Note that also in FIG. 4, Gaussian mode light having a wavelength of 1.55 μm is assumed, its mode field is indicated by solid lines, the outermost surfaces of the reflective mirror 4 and the semiconductor substrate 2 are indicated by a dashed line, and the mode field of the light reflected by the reflective mirror 4 is indicated by a dotted line.

With reference to FIG. 4, in a case where the spot size converter 6 is not integrated, when light with MFD=0.8 μm is emitted from the end face of the optical waveguide 3, a spread angle of the light is approximately 45 degrees, and vignetting occurs at the reflective mirror 4. As a result, as shown in FIG. 4, a part of the light is not reflected by the reflective mirror 4 and is not emitted in an intended direction.

From the above result of comparing FIG. 3 and FIG. 4, the effect of integrating the spot size converter 6 according to the first embodiment can be confirmed. Note that the MFD spread by the spot size converter 6 is preferably equal to or larger than 2 μm in order to perform the emission in the intended direction without the occurrence of vignetting at the reflective mirror 4.

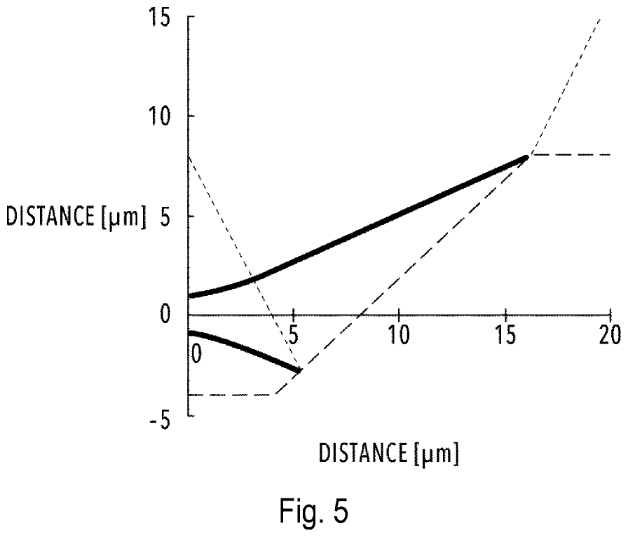

FIG. 5 is a diagram showing a calculation result for a spread effect of light when the surface emitting type light source 1A has the spot size converter 6 and MFD=2.0 μm is satisfied. Note that in FIG. 5, Gaussian mode light having a wavelength of 1.55 μm is assumed, and its mode field is indicated by solid lines. In addition, the outermost surfaces of the reflective mirror 4 and the semiconductor substrate 2 are indicated by a dashed line, and the mode field of the light reflected by the reflective mirror 4 is indicated by dotted lines.

With reference to FIG. 5, it can be seen that the light can be efficiently emitted in the intended direction as long as MFD=2.0 μm is satisfied or the MFD is equal to or larger than 2.0 μm in consideration of the result in FIG. 3. In contrast, when the MFD is smaller than 2.0 μm, the light cannot be efficiently emitted in the intended direction because vignetting of the light occurs.

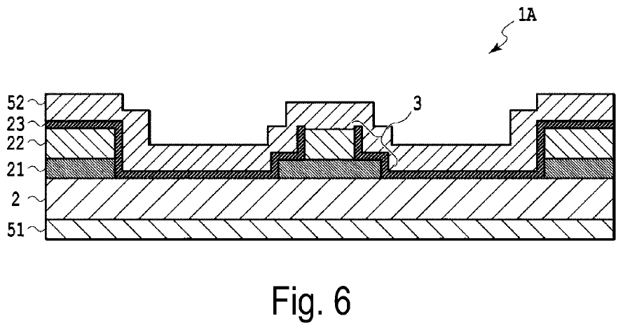

FIG. 6 is a cross-sectional view illustrating an end face structure of the surface emitting type light source 1A in a line VI-VI direction in FIG. 1. Note that the line II-II direction in FIG. 1 may be regarded as a length direction of the semiconductor substrate 2, and the line VI-VI direction in FIG. 1 may be regarded as a width direction of the semiconductor substrate 2.

With reference to FIG. 6, the p-type drive electrode 52 is formed on the top surface of the ridge type optical waveguide 3, and the n-type drive electrode 51 is formed on the bottom surface of the semiconductor substrate 2 throughout the entire region in the width direction of the semiconductor substrate 2. As a result, the bottom surface of the semiconductor substrate 2 can be contacted with the n-type drive electrode 51 in easy and convenient manner.

The surface emitting type light source 1A has such a configuration in which the light emitting surface and the various electrodes are not provided on the opposite surfaces to each other as in the case of the LISEL, and thus on-wafer measurement can be performed without cleaving the wafer.

This allows for appropriate on-wafer measurement without affecting element characteristics, and allows a surface emitting type optical device that is capable of high density packaging to be manufactured at low cost. Note that the surface emitting type optical device here includes a stage of the surface emitting type optical circuit fabricated in a process prior to forming various electrodes. As a result, applying such an optical device to a communication system contributes to high speed and large capacity communication.

### Second Embodiment

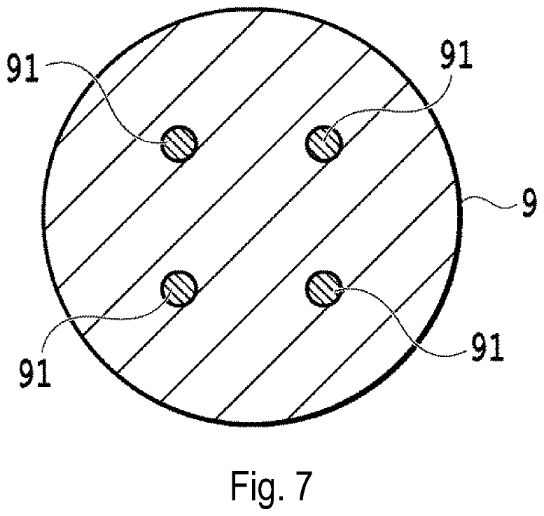

FIG. 7 is a cross-sectional view in an end face direction illustrating a basic structure of a multi-core fiber 9 to be used for coupling light that is branched by a surface emitting type light source according to a second embodiment as another example in which the surface emitting type optical circuit of the present invention is applied.

The surface emitting type light source according to the second embodiment is a multi-port output type that allows light emitted from one semiconductor laser 11 to be branched and can be coupled to cores, corresponding to the number of branches, of the multi-core fiber 9.

With reference to FIG. 7, the multi-core fiber 9 here includes four cores 91. A diameter of each core 91 is approximately 9 μm, and in order to efficiently couple light of a multi-port output type surface emitting type light source to the core 91, the MFD of the light needs to be approximately 9 μm at the end face of each core 91.

The light emitted from the optical waveguide 3 propagates and spreads out in free space, so the reflective mirror 4 may be brought closer to the optical waveguide 3 to reduce a propagation distance. In addition, when a lens is integrated on the upper portion of the reflective mirror 4 (the side of the top surface of the semiconductor substrate 2), spreading of the light is suppressed, and higher coupling efficiency can be achieved. Note that the number of cores 91 and the diameter of the core 91 described here are examples and are not limited to these numerical values.

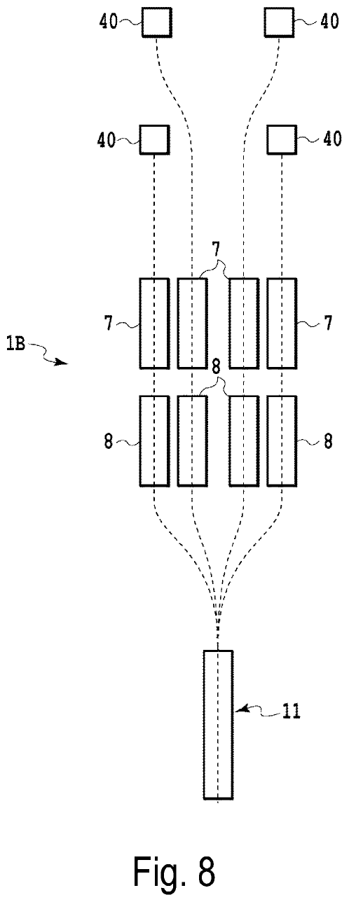

FIG. 8 is a plan view from a top surface direction illustrating a basic configuration of a surface emitting type light source 1B according to the second embodiment.

With reference to FIG. 8, the surface emitting type light source 1B according to the second embodiment is a multi-port output type that allows light emitted from one semiconductor laser 11 to be branched into four and is able to be coupled to the respective cores 91 of the multi-core fiber 9 illustrated in FIG. 7.

Specifically, the surface emitting type light source 1B is configured to allow light emitted from one semiconductor laser 11 to be reflected by the respective reflective mirrors 40 through four sets of optical waveguides 3 corresponding to the number of branches to emit the light toward the side of the top surface of the semiconductor substrate 2. Note that, here, an end region of each one set of four sets of the optical waveguides 3 is also provided with the spot size converter 6, which is not illustrated. In addition, in the middle of each of the four sets of optical waveguides 3, an optical amplifier 8 and an optical modulator 7 arranged in series independently for each one set are provided.

Of these, for the optical modulator 7, for example, an electro-absorption modulator, a Mach-Zehnder modulator, or the like can be applied, and the optical modulator 7 can be monolithically integrated on the top surface of the semiconductor substrate 2 together with the semiconductor laser 11. Providing the optical modulators 7 allows four channels of light to be transmitted in parallel by using one light source.

Additionally, the optical amplifier 8 includes a unique electrode and compensates for losses caused by branching of the optical waveguide 3, insertion of the optical modulator 7, and the like. Note that in FIG. 8, the optical amplifier 8 is disposed closer to the emission side of the semiconductor laser 11 than the optical modulator 7, but the relationship of the arrangement may be reversed. Note that this optical amplifier 8 is not always a necessary constituent element, but may not be provided as long as the losses described above are small.

Also concerning the surface emitting type light source 1B described above, on-wafer measurement can be performed without cleaving the wafer, similarly to the case of the first embodiment. This allows for appropriate on-wafer measurement without affecting element characteristics, and allows a surface emitting type optical device that is capable of high density packaging to be manufactured at low cost. As a result, applying such an optical device to a communication system further contributes to high speed and large capacity communication.

Note that in the surface emitting type light source 1B according to the second embodiment, the configuration of four branches corresponding to the number of cores 91 of the multi-core fiber 9 illustrated in FIG. 7 has been described, but the number of branches can be set as desired.

When N is a positive integer equal to or larger than 2, a surface emitting type light source that is of a typical multi-port output type basically includes a single semiconductor laser 11, and N sets of optical waveguides 3 and N sets of reflective mirrors 40 where the semiconductor laser 11 and its light are branched into N. Additionally, the surface emitting type light source also includes N sets of optical amplifiers 8 and light modulators 7 disposed therebetween. In other words, a case of N=4 corresponds to the configuration of the second embodiment illustrated in FIG. 8, but the second embodiment may be configured so as to satisfy N=3, or N=5 or larger.

In any case, the N sets of optical modulators 7 are necessary to perform N channels of optical transmission in parallel by one semiconductor laser 11, but the N sets of optical amplifiers 8 may be arranged as necessary and are not always necessary as described above.

Note that in each of the embodiments described above, a case has been disclosed in which the semiconductor laser 11 is integrated on the top surface of the semiconductor substrate 2, but the present invention is not limited to such a configuration. For example, a configuration may be applicable in which a photodiode (PD) that is a light receiving element is integrated in place of the semiconductor laser 11, and the optical modulators 7 are not provided to serve as a receiver. When the multi-core fiber 9 is connected to this configuration, light guided via the respective cores 91 can be made incident on an array of optical waveguides 3 through the reflective mirrors 40 and be detected by the photodiode. Such a configuration can be applied to configure a compact optical transmission and reception module in which a transmitter and a receiver are integrated on the same substrate.

In this manner, the present invention is not limited to the embodiments described above, various modifications are possible within a range that does not depart from the technical spirit thereof, and all technical matters included in the technical concept described in the claims are subject to the present invention. While the embodiments described above show suitable examples, those skilled in the art are able to realize various variations from the disclosed contents. In such cases, these are included in the appended claims.

### REFERENCE SIGNS LIST

1A, 1B Surface emitting type light source
2 Semiconductor substrate
3 Optical waveguide
4, 40 Reflective mirror
6 Spot size converter
7 Optical modulator
8 Optical amplifier
9 Multi-core fiber
11 Semiconductor laser
21 Active layer
22 Semiconductor layer
23 Insulating layer
51 n-type drive electrode
52 p-type drive electrode
61 Core layer
91 Core

1. A surface emitting type optical circuit comprising:
a spot size converter;
a substrate; and
an optical waveguide formed on a side of a top surface serving as one main surface of the substrate,
wherein
the spot size converter is provided in an end region of the optical waveguide,
the optical waveguide emits light into free space via the spot size converter,
the surface emitting type optical circuit further includes a reflective mirror configured to reflect light emitted from the optical waveguide toward the top surface.

2. The surface emitting type optical circuit according to claim 1, wherein a mode field diameter of light spread by the spot size converter is equal to or larger than 2 μm.

3. The surface emitting type optical circuit according to claim 1, wherein an outermost surface of the reflective mirror on the side of the top surface is metal.

4. The surface emitting type optical circuit according to claim 1, wherein an outermost surface of the reflective mirror on the side of the top surface is a dielectric multilayer film.

5. A surface emitting type light source applied with the surface emitting type optical circuit according to claim 1, the surface emitting type light source comprising:
a light source,
wherein the light source is integrated on the side of the top surface of the substrate.

6. The surface emitting type light source according to claim 5, wherein light from the light source is branched into N, N being a positive integer equal to or larger than two, and a structure of the optical circuit to which the branched light into N leads is a multi-port output type using a combination of N sets of the optical waveguides and the reflective mirrors configured.

7. The surface emitting type light source according to claim 6, wherein the optical waveguides include N optical modulators each of which modulates the corresponding light branched into N.

8. The surface emitting type light source according to claim 6, further comprising:
a multi-fiber having N number of cores at each of which the corresponding light branched into N is coupled.

9. The surface emitting type optical circuit according to claim 2, wherein an outermost surface of the reflective mirror on the side of the top surface is metal.

10. The surface emitting type optical circuit according to claim 2, wherein an outermost surface of the reflective mirror on the side of the top surface is a dielectric multilayer film.

11. A surface emitting type light source applied with the surface emitting type optical circuit according to claim 2, the surface emitting type light source comprising:
a light source,
wherein the light source is integrated on the side of the top surface of the substrate.

12. A surface emitting type light source applied with the surface emitting type optical circuit according to claim 3, the surface emitting type light source comprising:
a light source,
wherein the light source is integrated on the side of the top surface of the substrate.

13. A surface emitting type light source applied with the surface emitting type optical circuit according to claim 4, the surface emitting type light source comprising:
a light source,
wherein the light source is integrated on the side of the top surface of the substrate.

14. The surface emitting type light source according to claim 7, further comprising:
a multi-fiber having N number of cores at each of which the corresponding light branched into N is coupled.
